(19) United States
(12) Patent Application Publication
(10) Pub. No.: US 2014/0022541 A1
(43) Pub. Date: Jan. 23, 2014

(54) SYSTEMS AND METHODS FOR NEAR INFRA-RED OPTICAL INSPECTION

(71) Applicant: Diana Shapirov, Yokneam (IL)

(72) Inventor: Diana Shapirov, Yokneam (IL)

(21) Appl. No.: 13/947,179

(22) Filed: Jul. 22, 2013

Related U.S. Application Data
(63) Continuation-in-part of application No. 12/898,734, filed on Oct. 6, 2010, now Pat. No. 8,492,721.
(60) Provisional application No. 61/251,936, filed on Oct. 15, 2009.

(51) Int. Cl. G01N 21/956

(52) U.S. Cl. CPC G01N 21/956
USPC 356/237.5

(57) ABSTRACT

An inspection system and a method for defect detection, the method includes: generating a first beam that includes a near infrared spectral component and a visible light component; directing at least the near infrared spectral component towards a backside of an inspected object, the backside includes first elements made of a substantially transparent to near infrared radiation first material and second elements that are made of a second material arranged to reflect near infrared radiation; directing, towards a sensor, a near infrared spectral component of a second beam generated from the illuminating of the inspected object; wherein the sensor is sensitive to visible light radiation and to near infrared radiation; generating, by the sensor, detection signals that are responsive to the near infrared component of the second beam; and detecting at least one attribute of at least the second elements by processing the detection signals.

### RELATED APPLICATIONS

This application is a continuation in part of U.S. patent application Ser. No. 12/898,734 which claims priority from U.S. patent provisional patent Ser. No. 61/251,936, filing date Oct. 15 2009, and both application being incorporated herein by reference.

### BACKGROUND OF THE INVENTION

Printed Circuit Boards (PCBs) include Copper conductors. Copper conductors may get oxidized. While copper oxidation does not cause PCB failures, the color change associated with the oxidation often causes many false alarms (false positives) during optical inspection.

Cupric Oxide, Cuprous Oxide, Copper Chloride and Copper Carbonate tend to absorb light and to be imaged as dark pixels that once compares to Copper cause false positives. Similar effects may occur in other oxidized metals in inspected objects.

Other chemical reactions may also result in color change, while not severely reducing the performance of the chemically reacted object (e.g. the copper conductors).

There is a growing need to provide robust optical inspection systems and methods that are less sensitive to Copper oxidation.

### SUMMARY

According to an embodiment of the invention a method and system for defect detection is provided.

### BRIEF DESCRIPTION OF THE PRESENT INVENTION

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

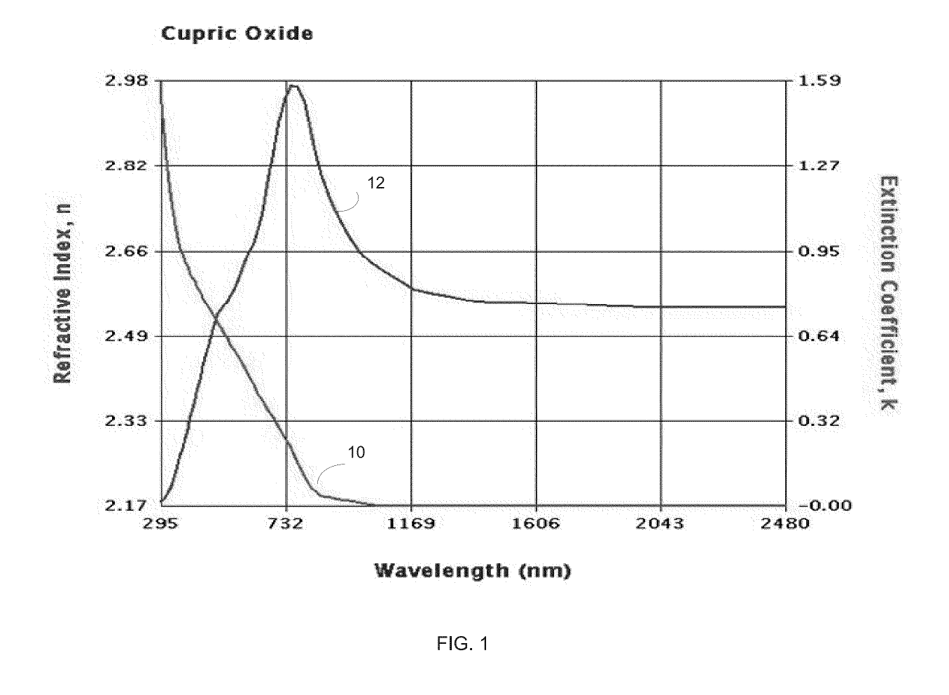

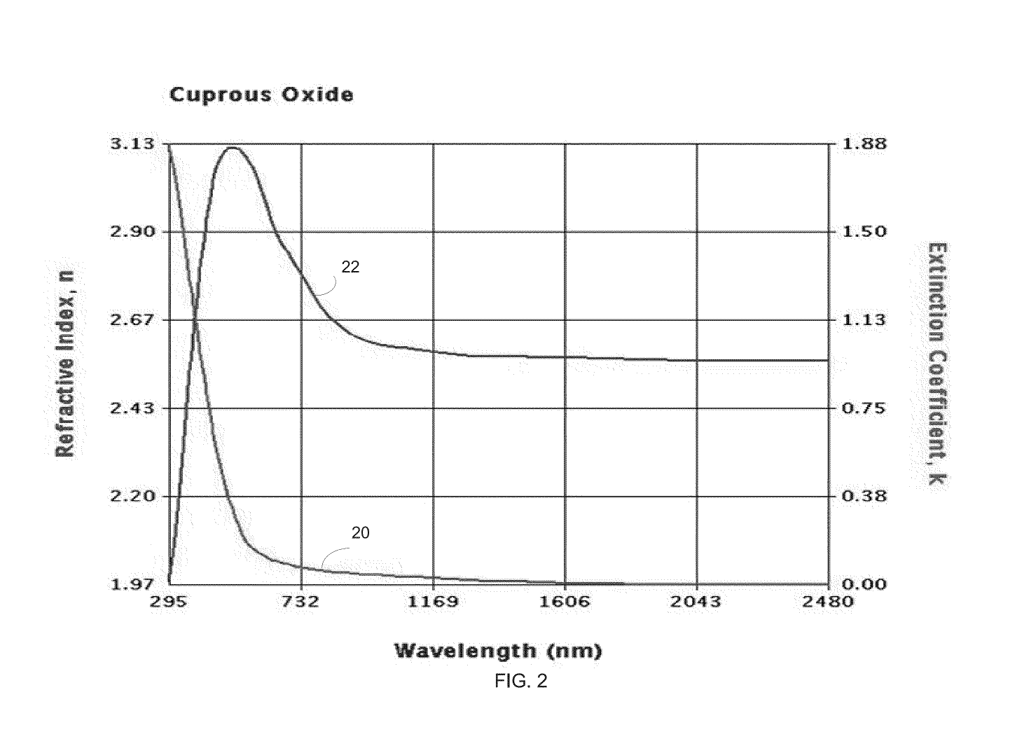

FIGS. 1 and 2 illustrate reactive index (n) and extinction coefficient (k) of Cupric Oxide and of Cuprous Oxide;

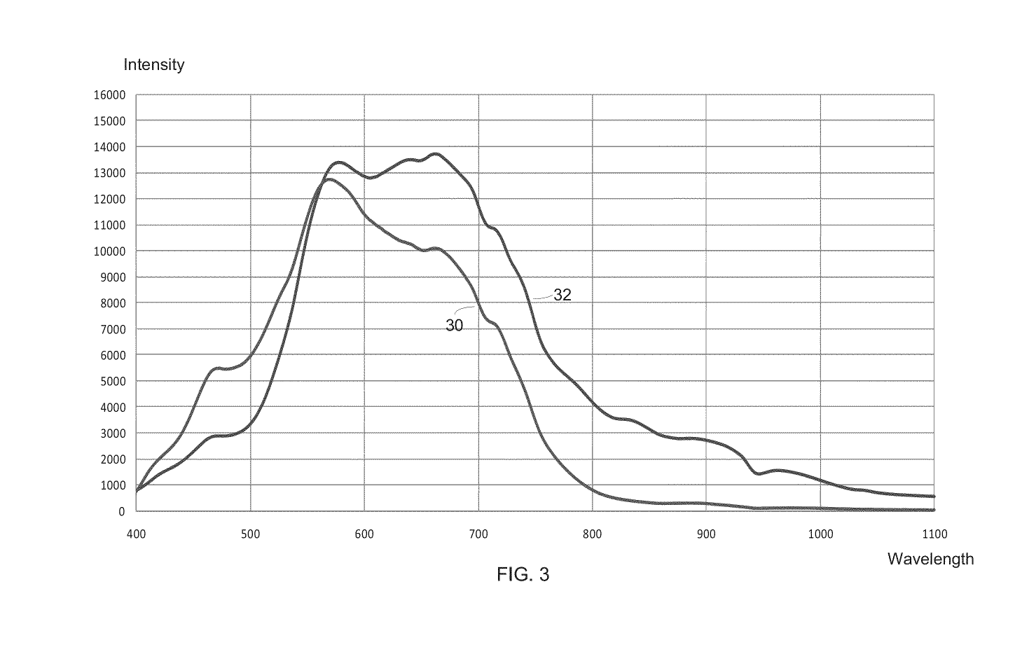

FIG. 3 illustrates a spectrum of two illumination sources according to an embodiment of the invention;

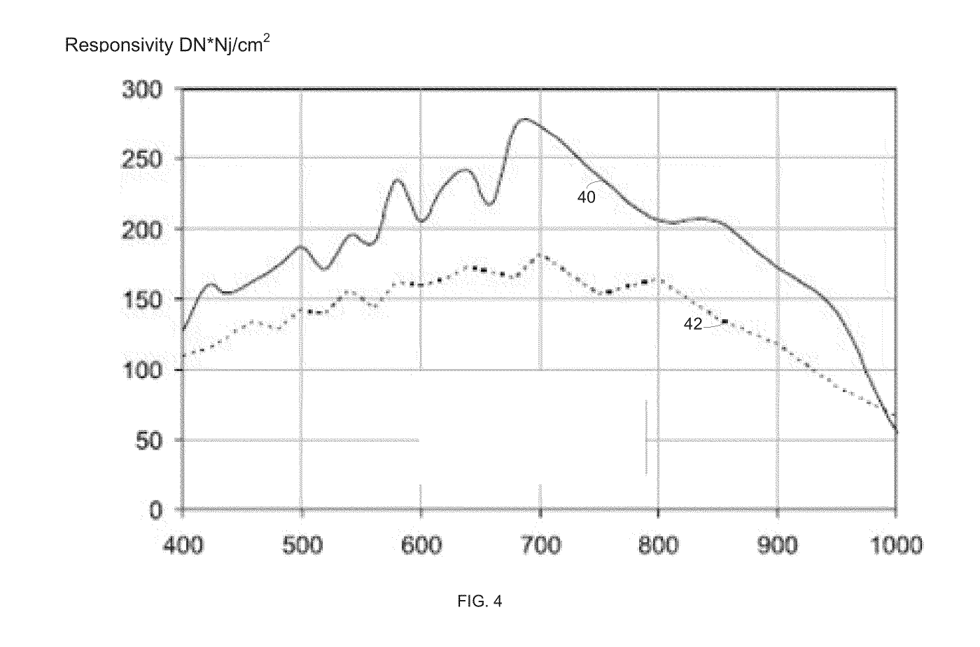

FIG. 4 illustrates a sensitivity of a Piranha 3 CCD camera of Dalsa Inc;

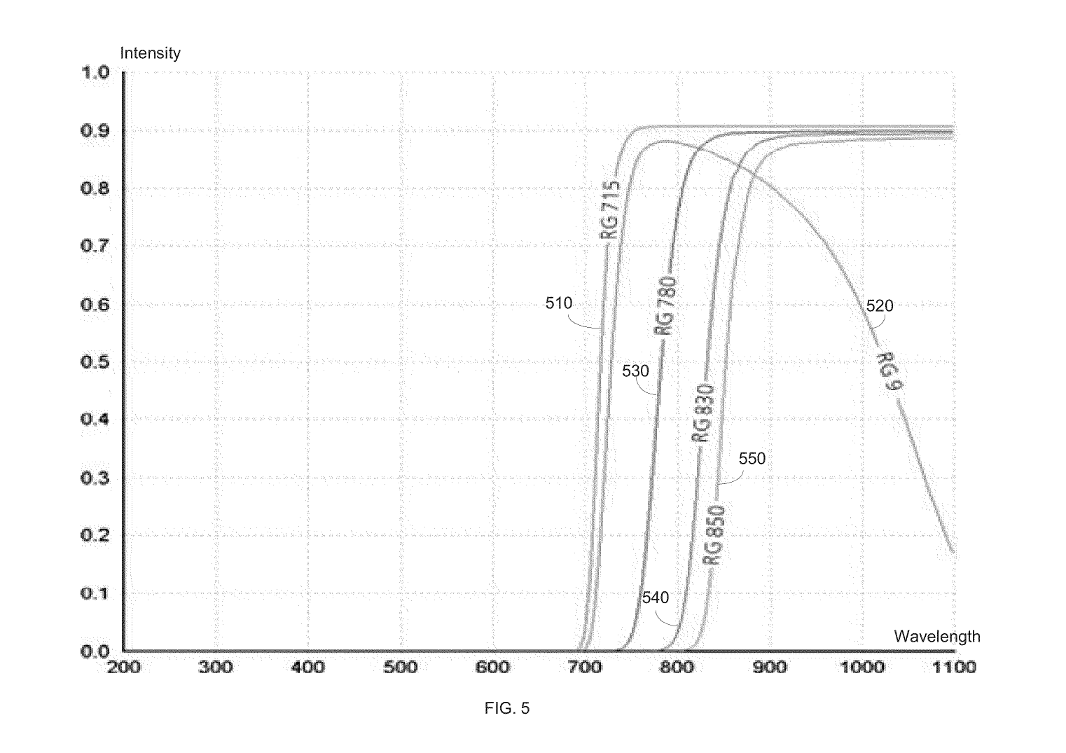

FIG. 5 illustrates transmission functions of various visible light blocking filters;

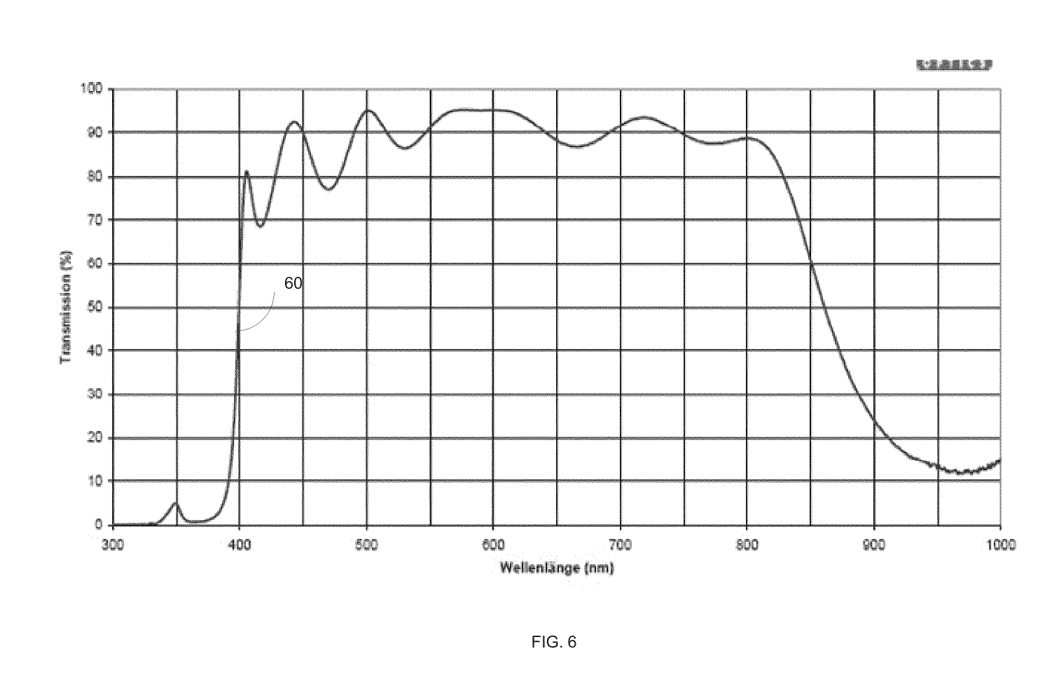

FIG. 6 illustrates a transmission function of an IR6 glass that functions as a hot mirror;

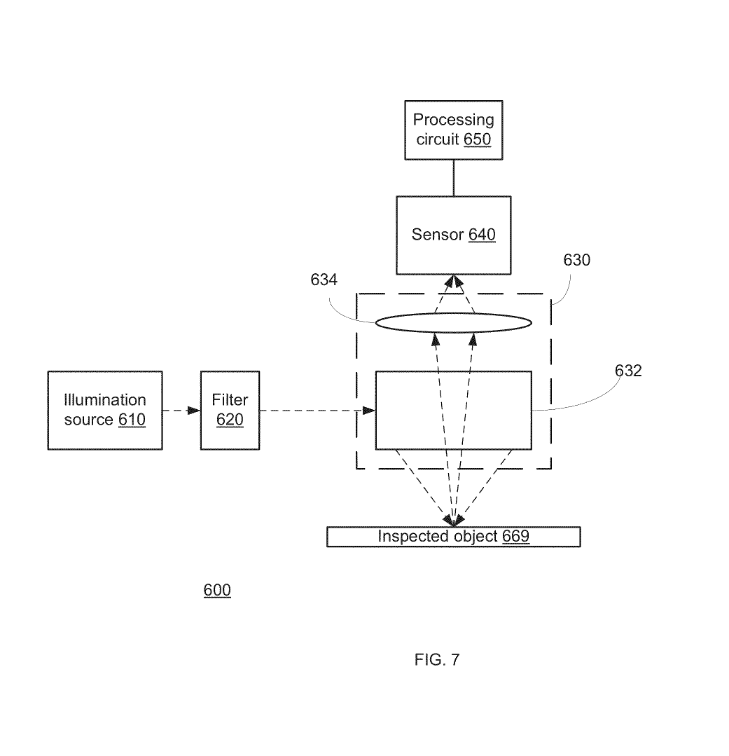

FIG. 7 illustrates an inspection system according to an embodiment of the invention;

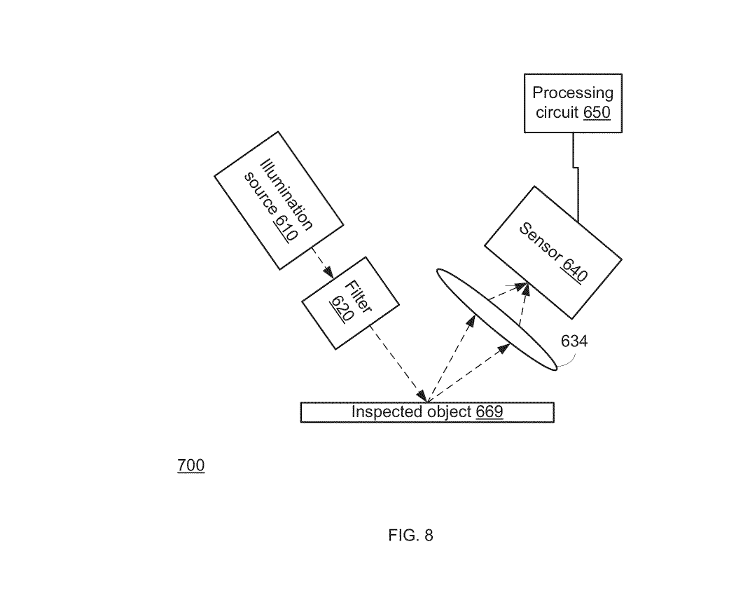

FIG. 8 illustrates an inspection system according to another embodiment of the invention;

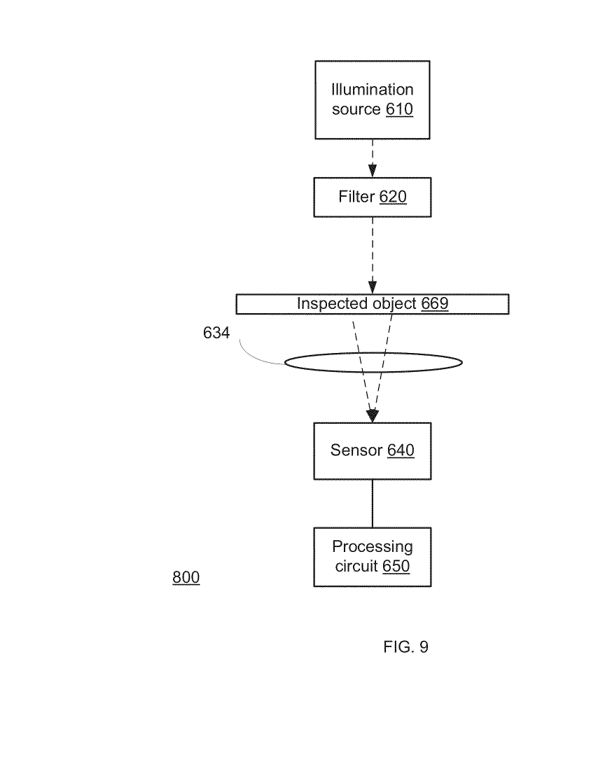

FIG. 9 illustrates an inspection system according to a further embodiment of the invention;

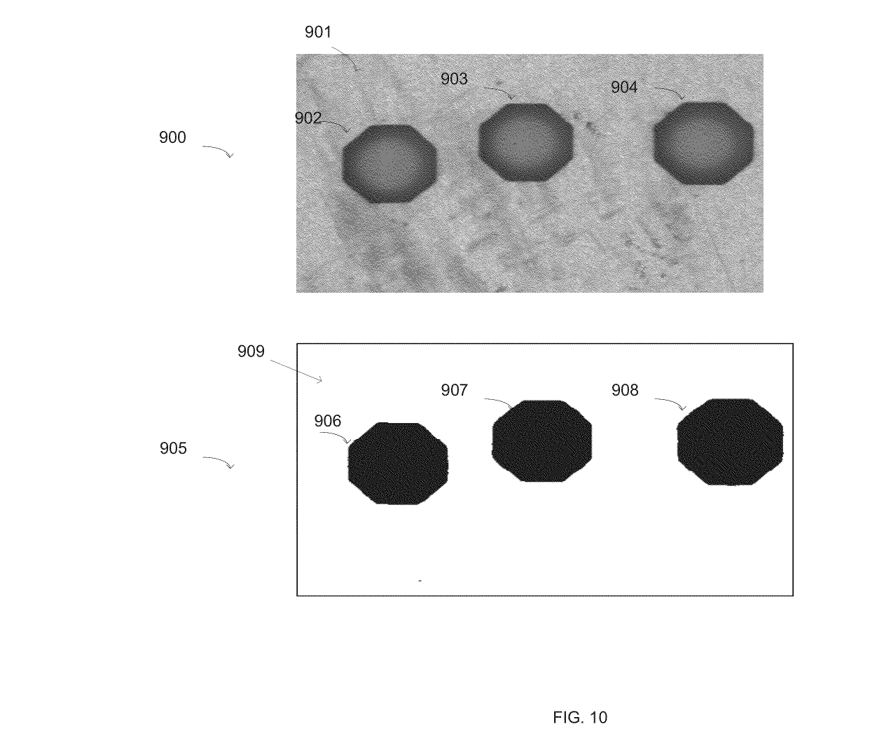

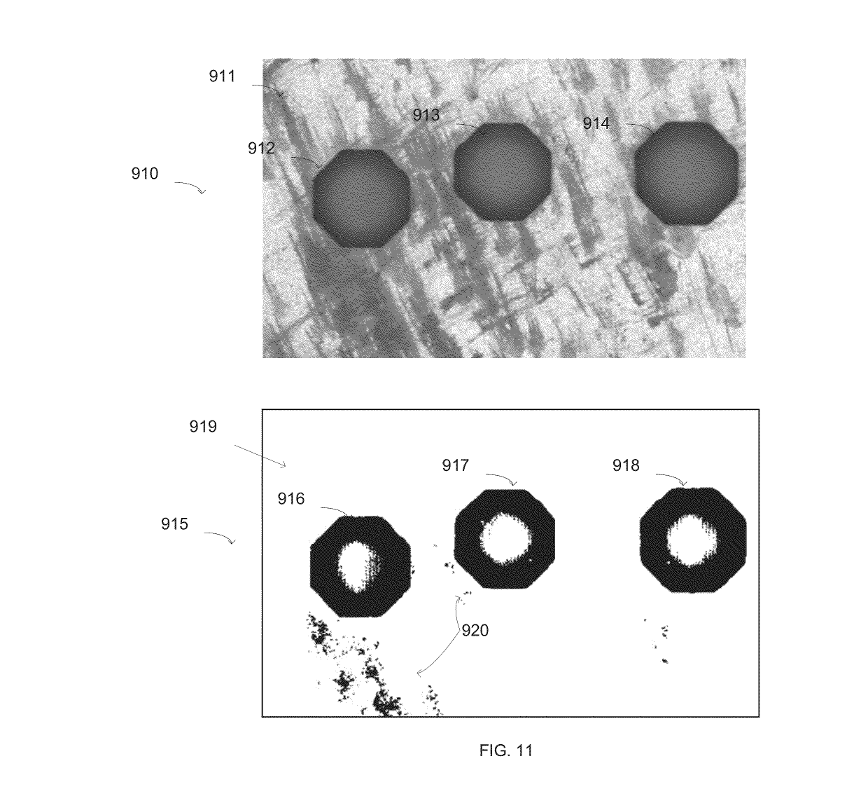

FIGS. 10 and 11 illustrate images of an area of an inspected object and binary images of the area, according to an embodiment of the invention;

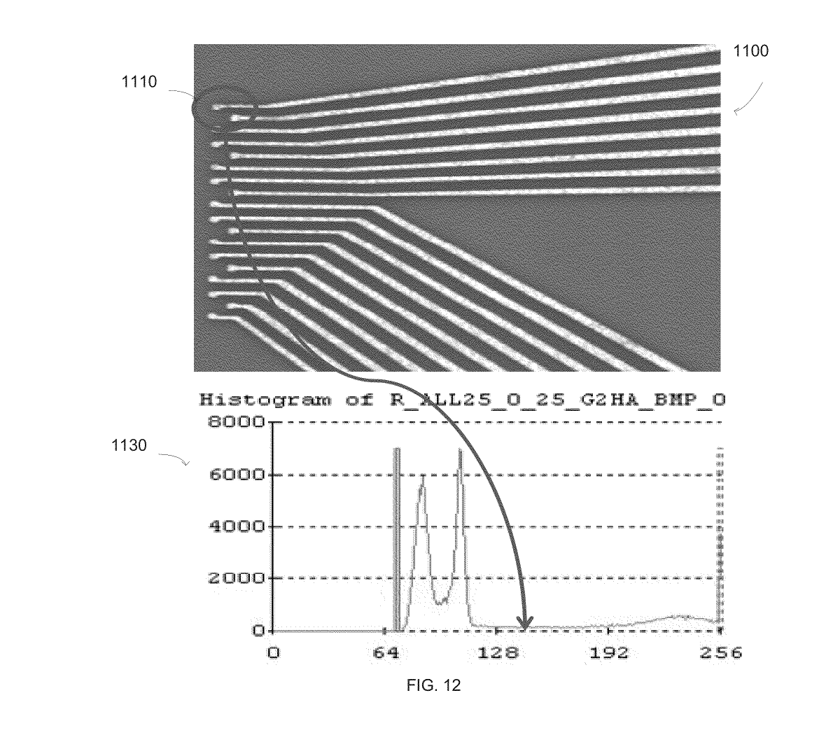

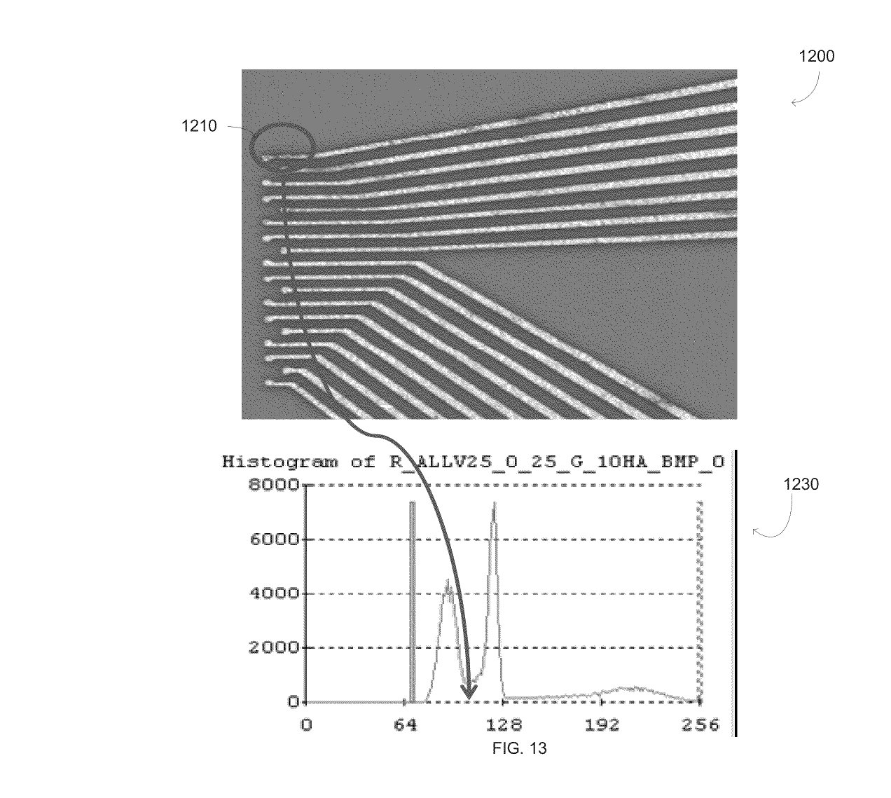

FIGS. 12 and 13 include images of narrow conductors placed on a Rodgers laminate material, obtained with different radiation bands and also illustrate histograms of portions of these images, according to an embodiment of the invention;

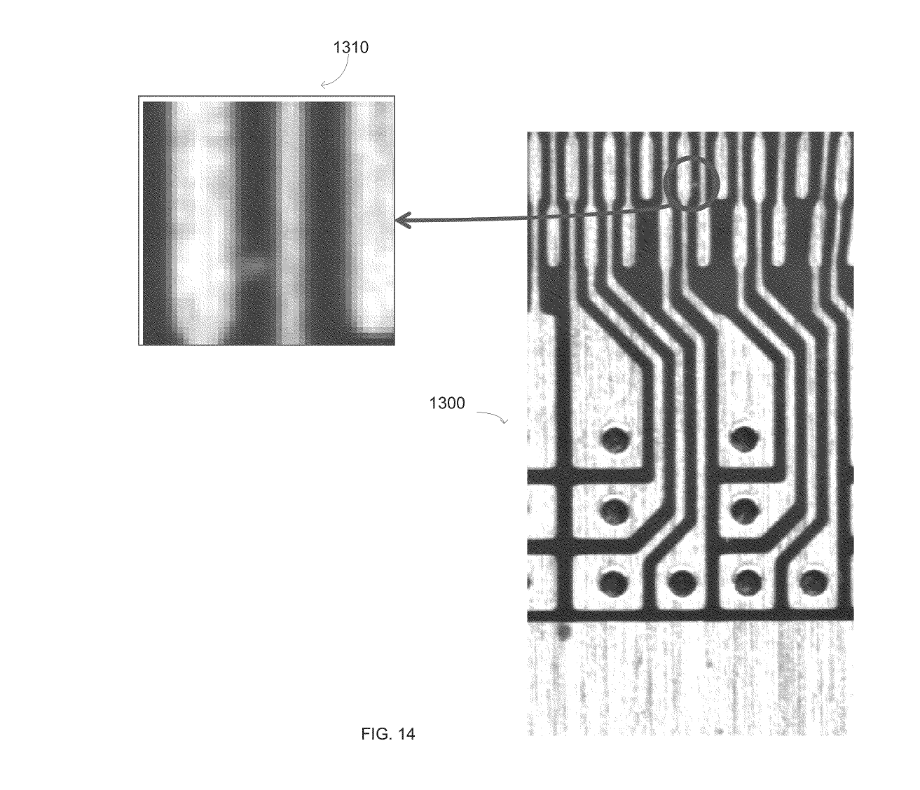

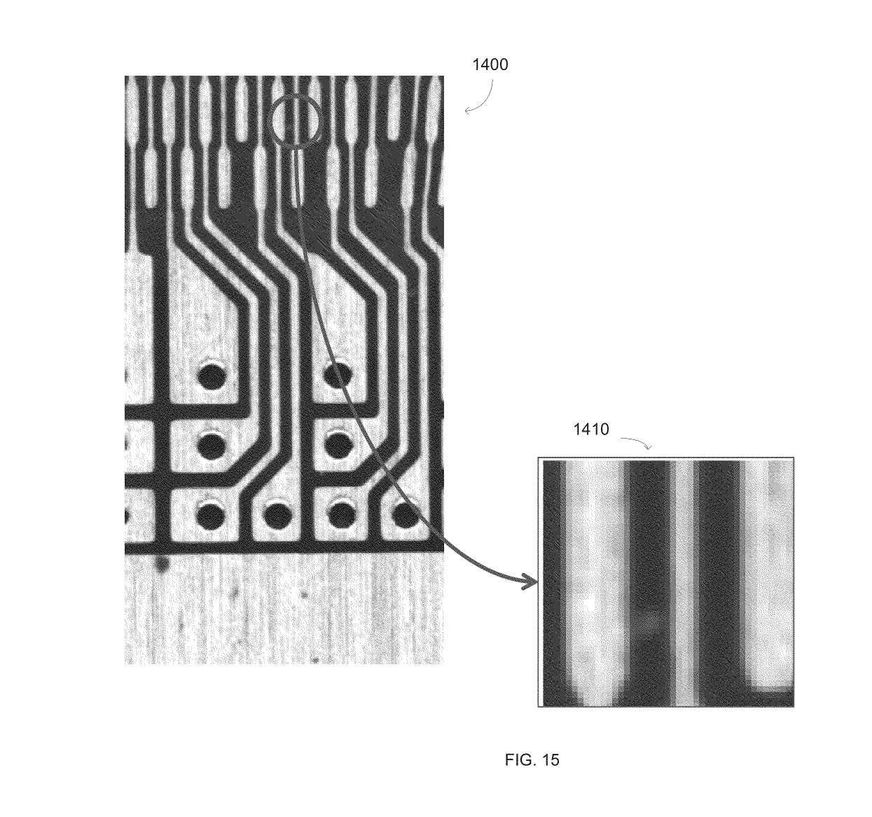

FIGS. 14 and 15 include images of a PCB that includes copper conductors placed on a laminate material and enlarged portions of these images, obtained in different wavelength ranges, according to an embodiment of the invention;

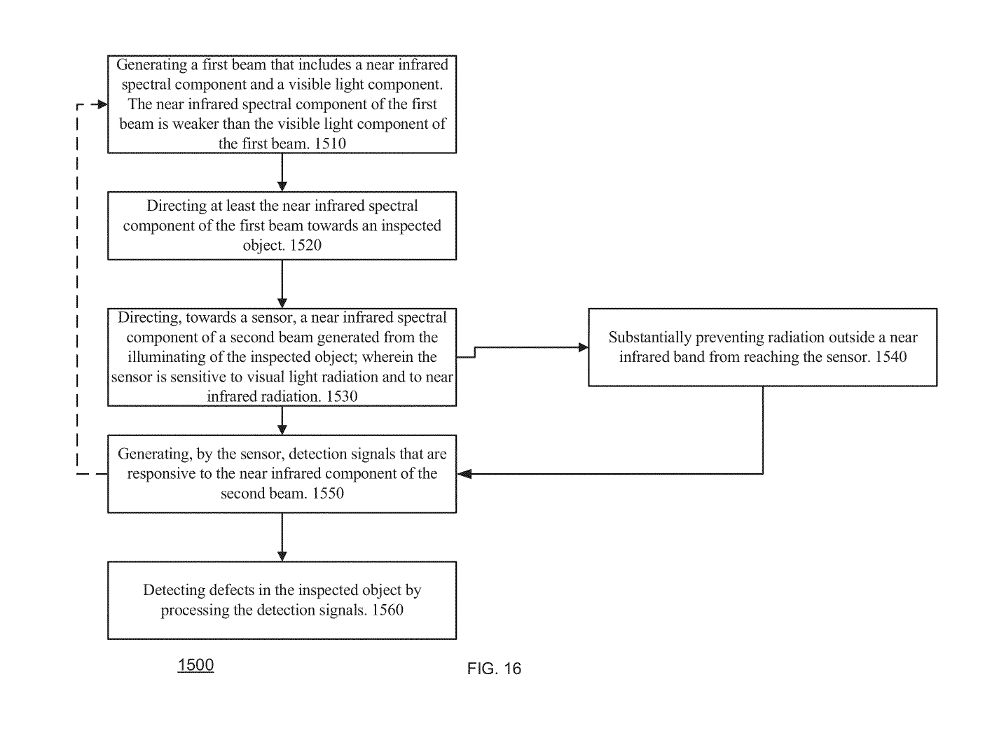

FIG. 16 illustrates a method for defect detection, according to an embodiment of the invention;

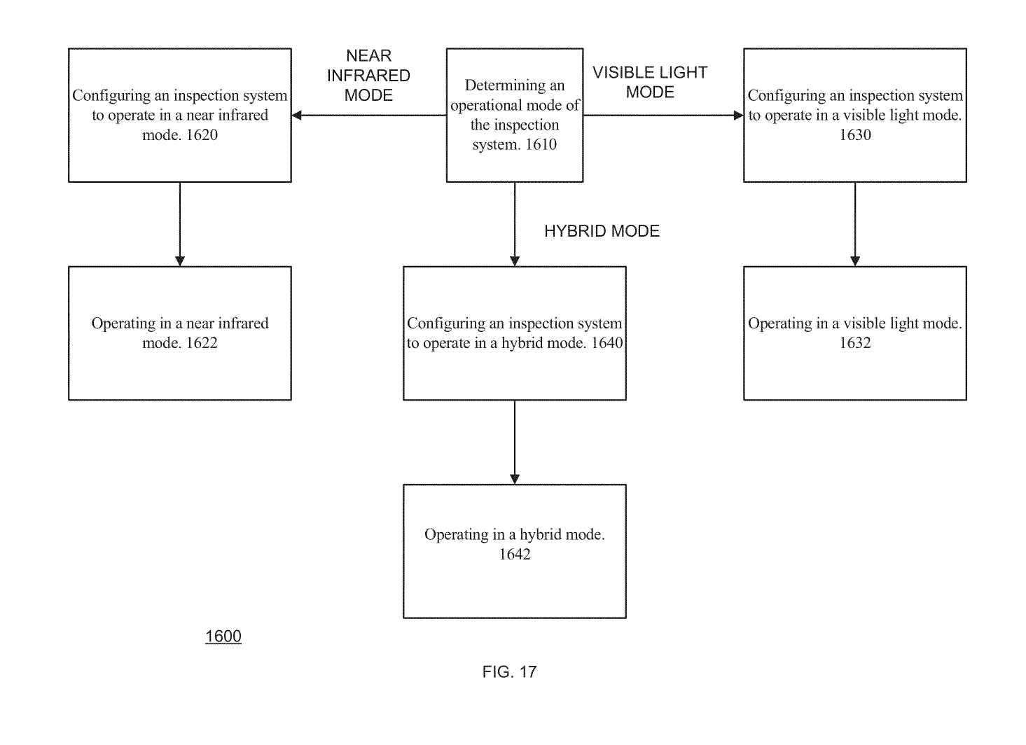

FIG. 17 illustrates a method for defect detection, according to another embodiment of the invention;

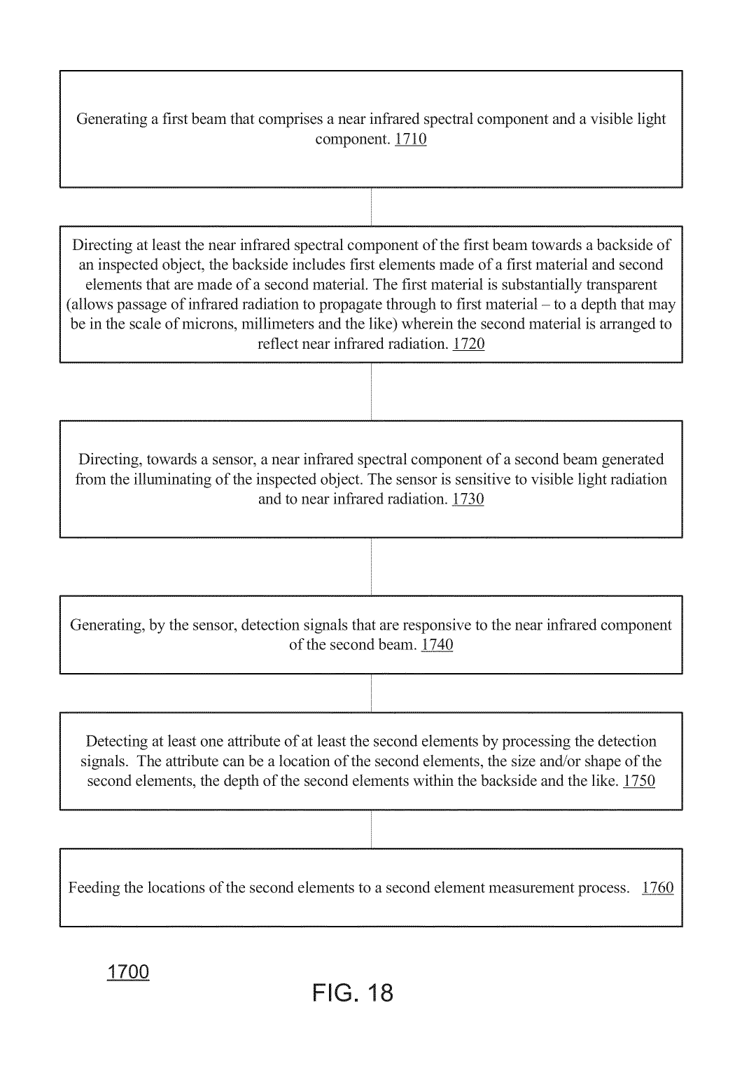

FIG. 18 illustrates a method for defect detection, according to another embodiment of the invention;

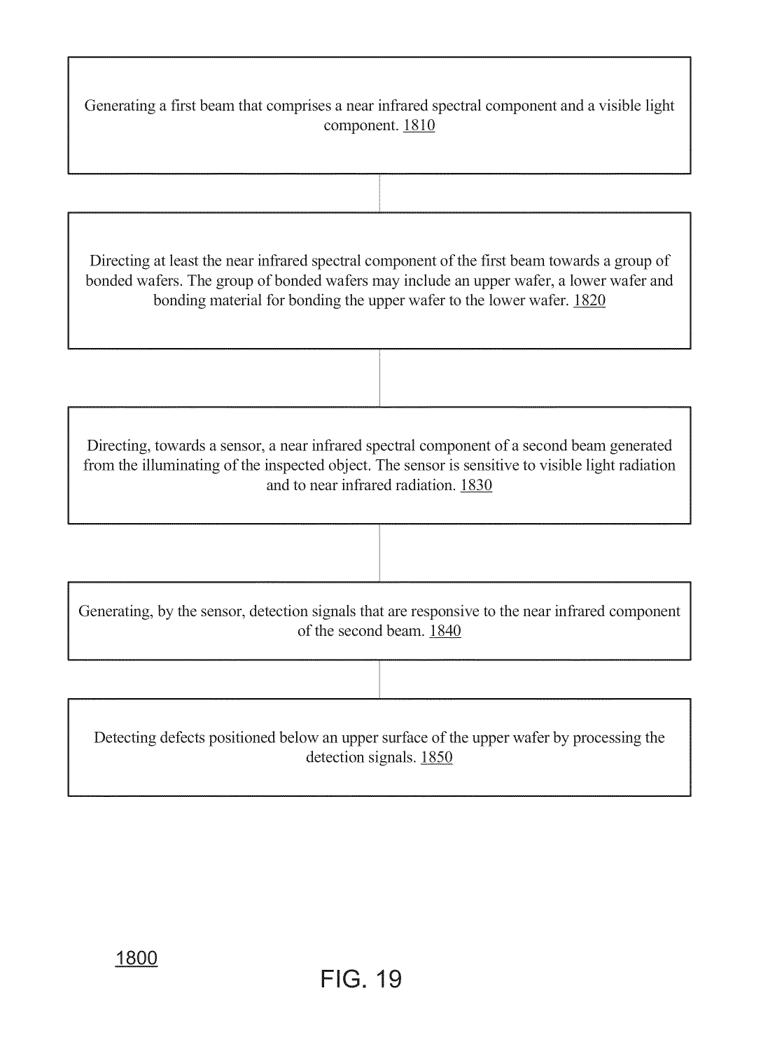

FIG. 19 illustrates a method for defect detection, according to another embodiment of the invention;

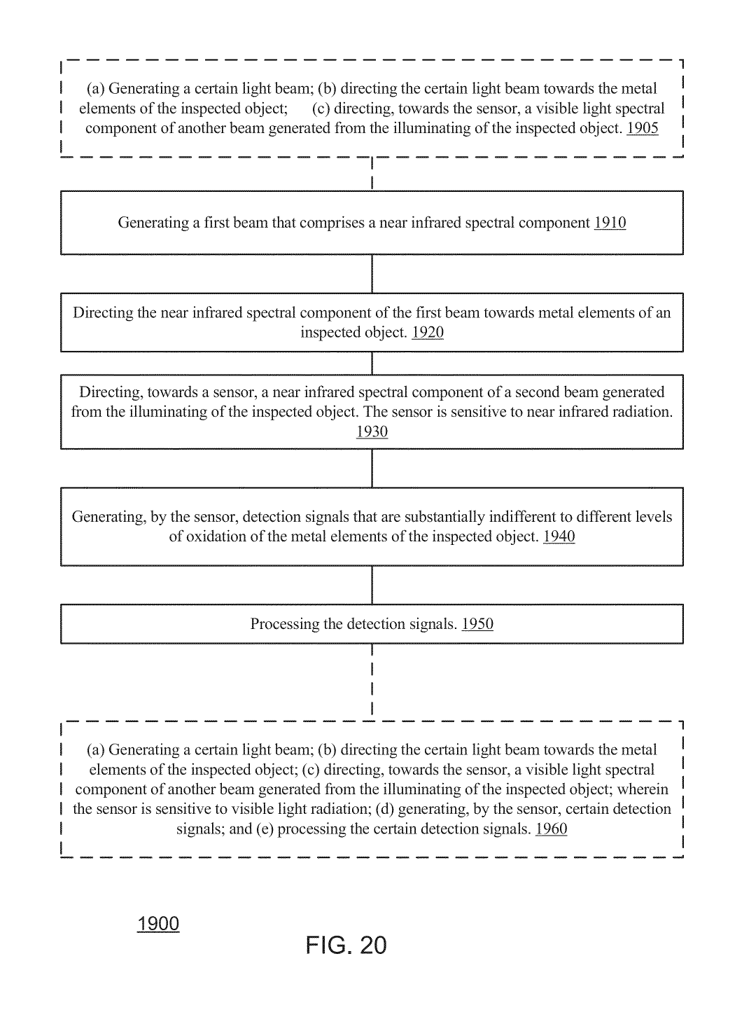

FIG. 20 illustrates a method for defect detection, according to another embodiment of the invention;

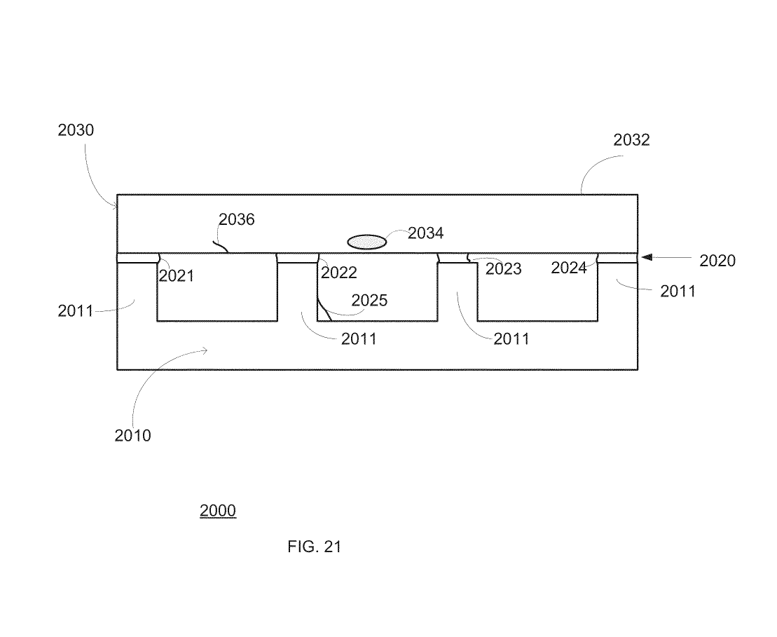

FIG. 21 illustrates a cross section of group of bonded wafers, according to another embodiment of the invention; and

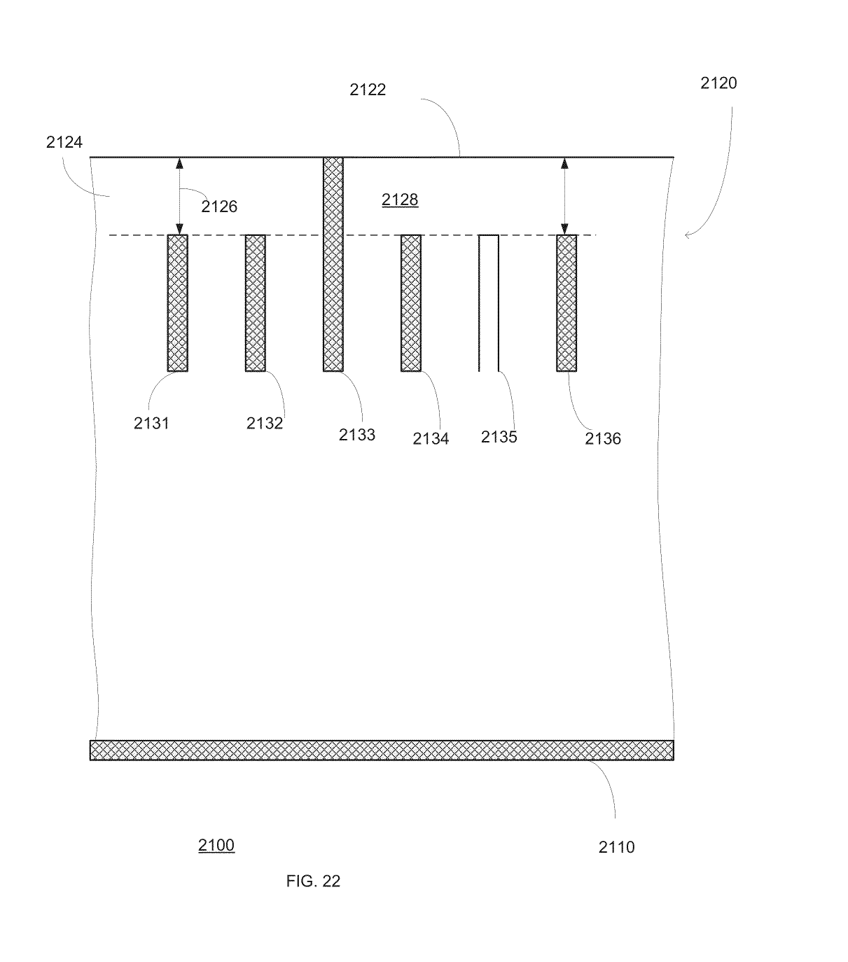

FIG. 22 illustrates a cross section of a portion of a wafer according to an embodiment of the invention.

### DETAILED DESCRIPTION OF THE PRESENT INVENTION

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A method and an inspection system are provided. The inspection system may include a sensor that may operate in the visible light band and in the near infrared band and the method may include inspecting an inspected object at a near infrared band. The inspected object can include micro-metric and even nano-metric structures. The inspected object can be, for example, a semiconductor wafer, a printer circuit board (PCB), a wafer level package (WLP) wafer, one or more dice, one or more WLP dice, a lithographic mask, a MEMS (micro electrical mechanical system), and the like.

The wafer level package wafer (WLP) can be manufactured by attaching a several packaging layers on a semiconductor wafer and only after this attachment the product is diced to provide already packaged dices. It has been found that applying the suggested methods and systems on WLP wafers or WLP dice can reveal defects such as packaging related defects (misplacement of dice, glue or bonding materials misplacement, cracks in the package we well as dice defects).

A desired upper boundary of the desired radiation band can be learnt from FIGS. 1 and 2. Radiation that has a wavelength below (or frequency above) the wavelength of the upper boundary should be blocked.

FIGS. 1 and 2 illustrate a reactive index (n) and an extinction coefficient (k) of Cupric Oxide and of Cuprous Oxide.

Curve 10 of FIG. 1 illustrates that the extinction coefficient of Cupric Oxide strongly decreases between the wavelengths of 295 nm and about 900 nm and slowly decreases between 900 nm and about 1000 nm. The extinction coefficient of Cupric Oxide is nearly zero above 1000 nm. Curve 12 of FIG. 1 illustrates that the refractive index of Cupric Oxide strongly increases between the wavelengths of 295 nm and 750 nm and then strongly decreases till about 1000 nm. The refractive index of Cupric Oxide slowly decreases till reaching a level of about 2.55 above 1400 nm.

Curve 20 of FIG. 2 illustrates that the extinction coefficient of Cuprous Oxide strongly decreases between the wavelengths of 295 nm and about 500 nm, decreases between 500 nm and about 700 nm and slowly decreases between 700 nm and 1606 nm. The extinction coefficient of Cuprous Oxide is nearly zero above 1300 nm. Curve 22 of FIG. 2 illustrates that the refractive index of Cuprous Oxide strongly increases between the wavelengths of 295 nm and 500 nm, decreases between 500 nm and about 850 nm and then slightly decreases till about 1200 nm. Between 1200 nm and 2480 nm the refractive index of Cuprous Oxide reaches a level of about 2.55.

Higher extinction coefficient values indicate that more light is absorbed and more dark pixels will appear in an image—thus causing more false defect calls.

A desired lower boundary of the desired radiation band can be learnt from FIGS. 3 and 4. Radiation that has a wavelength above (or frequency below) the wavelength of the lower boundary should be blocked.

FIG. 3 illustrates a spectrum of two illumination sources. Curve 30 illustrates a spectrum of an illumination source that includes a L6409-G lamp with a Gold reflector and curve 32 illustrates a spectrum of an illumination source that includes an ELC-5h lamp with a Dichroic reflector.

Curve 30 illustrates that the combination of a L6409-G lamp and a Gold reflector emits radiation in the visible light and near infrared bands. Although the near infrared spectral components of the radiation is much weaker (visible light spectral components at wavelengths that range between 580 nm and 670 nm are about 13 times stronger than the near infrared spectral component at about 1000 nm). Nevertheless, these near infrared spectral components can still be used to illuminate an inspected object.

Curve 32 illustrates that an illumination source that includes an ELC-5h lamp with a Dichroic reflector less suitable then the combination of the L6409-G lamp and the Gold reflector for near infrared illumination as it omits nearly no radiation above 900 nm Nevertheless, such an illumination source can be used when only a portion (for example 700 nm-800 nm) of the near infrared spectrum is used.

FIG. 4 illustrates a sensitivity of two CCD cameras Piranha 3 from Dalsa Inc., USA (Canada).

Curve 40 illustrates a sensitivity of a Piranha 3 CCD camera that has 5 micron pixels and curve 42 illustrates a sensitivity of a Piranha 3 CCD camera that has 7 micron pixels. In both cases the sensitivity strongly decreases above about 800 nm. At a wavelength of about 1000 nm the sensitivity of the 7 micron pixel camera is about 60 DN*Nj/cm² while the sensitivity of the 5 micron pixel is about 70 DN*Nj/cm². The peak sensitivity of the 5 micron camera is about 175 DN*Nj/cm²and the peak sensitivity of the 7 micron camera is about 275 DN*Nj/cm². Although not shown in this figure, the cut off frequency is about 1100 nm. This cut off frequency may determine the upper boundary of the desired radiation band.

According to an embodiment of the invention the desired radiation band is the near infrared band and especially wavelengths that range between about 700 nm and about 1100 nm. It is noted that the desired radiation band can also range between 710, 750, 800 and even 820 nm to about 900 nm, 1000 nm, 1100 nm or 1200 nm. Any portion of the 700 nm and about 1100 nm band can be used.

Radiation that is outside the near infrared band should be prevented from reaching the sensor, or at least substantially attenuated before reaching the sensor. Mid-infrared radiation and deep infrared radiation may cause strong image degradation if working with non-specialized imaging optics and sensor of an inspection system while visible light radiation introduces errors.

Various transmission functions of various visible light blocking filters are illustrated by curves 510, 520, 530, 540 and 550 of FIG. 5. These curves illustrate the transmission function of visible light blocking filters that filter radiation of wavelengths below 700 nm (RG715), below about 710 nm (RG9 filter), below about 750 nm (RG780), below about 800 nm (RG830) and below about 820 nm (RG 850).

Curve 60 of FIG. 6 illustrates a transmission function of an IR6 glass that functions as a hot mirror—a filter that blocks mid infrared and far infrared radiation. Curve 60 illustrates a strong decrement in the transmission of radiation above 850 nm and especially illustrates a very low transmission factor at about 1000 nm.

According to an embodiment of the invention an inspection system may be provided. The inspection system may include a sensor that is sensitive to near infrared (NW) radiation. This sensor can be also sensitive to visible light radiation and can be a low cost and even a standard visible light sensor. Such sensors are cheaper and even much cheaper than dedicated infrared sensors.

The inspection system may also include optics such as an imaging lens that may be a low cost and even a standard imaging lens that does not strongly degrade in NIR. The system may also include a light source that emits NIR radiation (possibly not restricted to NW radiation) such as a low cost visible light source, and also includes a band pass filter. The band pass filter may include a hot mirror that transmits NIR radiation and rejects mid infrared radiation and far infrared radiation and has a cut-on filter that rejects visible light. The hot mirror can be an extended hot mirror and can be a standard and even a low cost hot mirror.

It is noted that the band-pass filter may include components other then the hot-mirror and cut-on filter.

The optics may include a beam splitter that receives a first beam from an illumination source, directs it towards the inspected object, receives a second beam from the inspected object and directs the second beam towards the sensor.

FIG. 7 illustrates an inspection system 600 according to an embodiment of the invention.

The inspection system 600 may include an illumination source 610, a filter 620, optics 630, a sensor 640 and a processing circuit 650.

The illumination source 610 may be arranged to generate a first beam that includes a near infrared spectral component and a visible light component. The near infrared spectral component of the first beam may be weaker and can be much weaker than the visible light component of the first beam. This is not necessarily so and the near infrared spectral component of the first beam may be stronger than the visible light component of the first beam or equal to it.

The optics 630 is arranged to: (i) direct at least the near infrared spectral component of the first beam towards an inspected object; and (ii) direct, towards the sensor 640, a near infrared spectral component of a second beam generated from the illuminating of the inspected object 669.

The filter 620 is arranged to substantially prevent radiation outside a near infrared band from reaching the sensor 640. The substantially prevention of radiation may include allowing an insignificant amount of radiation outside the near infrared band to reach the sensor 640. The amount of radiation that is regarded as insignificant is determined in advance and can reflect an intensity of such radiation or an upper bound to the allowed error rate introduced by such radiation. Substantially preventing radiation can also be determined by the attenuation level of such radiation—for example an attenuation of 5 db, 10 db or more. FIGS. 5 and 6 provide non-limiting examples of transfer functions of a hot mirror and a cut-on filter that may form such a band pass filter.

The sensor 640 is sensitive to visible light radiation and to near infrared radiation. After the filtering operation of the filter 620, the sensor 640 is expected to provide detection signals that are responsive to the near infrared component of the second beam.

The processing circuit 650 is arranged to detect defects in the inspected object by processing these detection signals. The processing circuit 650 can include a memory module that stores the detection signals. Alternatively, the processing circuit 650 can be access a memory module that stores these detection signals.

It is further notes that the inspection system 600 can also include other components that are not shown for simplicity of explanation, such as (a) a mechanical stage that may support the inspected object 669 and may introduce movement between the inspected object 669 and either one of the optics 630, (b) a display, (c) a control panel, (d) an auto-focus circuit, and the like.

FIG. 7 illustrates optics 630 as including a beam splitter 632 and an imaging lens 634. FIG. 7 also illustrates filter 620 being located between the illumination source 610 and the beam splitter 632. It is noted that other configurations can be provided. For example, the filter 620 can be located between the beam splitter 632 (or the imaging lens 634) and the sensor 640. Yet for another example, the optics 630 may not include a beam splitter. Yet for another example, the optics 630 may include other components or additional optical components.

In the example illustrated in FIG. 7, the illumination source 610 generates a first light beam that includes a near infrared spectral component and a visible light component. It is noted that each of these spectral components can be monochromatic, narrow band or even wideband. A spectral component can include a single wavelength or a group of multiple wavelengths that can range between few nanometers end even hundred of nanometers. In the example set forth in FIG. 3 the visible light spectral component ranges between 400 and 700 nm and the near infrared spectral component ranged between 700 nm and 1100 nm. Although not shown in FIG. 3, this first beam can include mid infrared and deep infrared spectral components.

The strength (intensity) of a spectral component can be represented by any predetermined function of the intensity of that spectral component. Non-limiting examples of such a predetermined function include a maximal intensity, an average intensity, a minimal intensity, a weighted average intensity and the like. Thus, a near infrared spectral component of a beam that is substantially weaker than a visible light spectral component of the beam means that the values of the predetermined function of the near infrared spectral component of a beam and of the predetermined function of the visible light spectral component indicate that the near infrared spectral component of the beam is substantially weaker than the visible light spectral component of the beam.

The filter 620 blocks spectral components other that the near infrared component of the first beam from reaching the beam splitter 632. The beam splitter 632 directs the near infrared spectral component of the first beam towards the inspected object 669 and also directs a near infrared component of a second beam (generated as a result of the illumination of the inspected object 669 by the near infrared spectral component of the first beam) towards imaging lens 634 and sensor 640.

If, for example, the filter 620 is located between the sensor 640 and the imaging lens 634 then the first light beam (including a spectral component outside the near infrared band) is directed by the beam splitter 632 towards the inspected object 669, a second light beam (including a spectral component outside the near infrared band) is directed by the beam splitter 632 towards the imaging lens 634 and is filtered before reaching the sensor 640.

FIG. 8 illustrates an inspection system 700 according to another embodiment of the invention.

Inspection system 700 differs from inspection system 600 by its optics 630—it does not include a beam splitter and both the illumination path (over which the first beam propagates towards the inspected object) and the collection path (over which the second beam propagates towards the sensor) are oriented in relation to an imaginary normal to the inspected object 669.

As illustrated in FIG. 8, the filter 620 follows the illumination source 610 and the near infrared component of the first beam impinges on the inspected object at an angle of about 60 degrees in relation to the normal to the inspected object 669. The near infrared component of the second beam is collected by the imaging lens 634 at a collection angle of about −60 degrees in relation to the imaginary normal.

Although the collection path and the illumination path of inspection system 700 are symmetrical about the imaginary normal this is not necessarily so and the collection angle can differ from the illumination angle.

The configuration of FIG. 8 is beneficial in the sense that the imaging lens 634 collects reflected radiation (of significant intensity) and that the illumination substantially differs from normal illumination—thus reducing the affect of oxidation on the detected signals. Thus, oxidized metals will appear as non-oxidized metals. Even oxidized defects can be better images as the detection signals are substantially indifferent to the oxidation of the oxidized defects.

In either one of inspection systems 600 and 700 the near infrared spectral component of the first beam may be substantially weaker than the at least one visible light component of the first light beam.

In either one of inspection systems 600 and 700 the sensor 620 may be arranged to generate detection signals that are substantially indifferent to different levels of oxidation of the metal elements of the inspected object.

In either one of inspection systems 600 and 700 the near infrared spectral component of the first beam is at least ten times weaker than the visible light component of the first beam.

FIG. 9 illustrates an inspection system 800 according to another embodiment of the invention.

Inspection system 800 differs from inspection system 600 by its optics 630 and by the location of sensor 640. Inspection system 800 operates in a transmissive mode and does not include a beam splitter. Sensor 640 and illumination source 610 are positioned at opposite sides of the inspected object 669. For example, illumination source 610 can be positioned above the inspected object 669 while the sensor 640 can be positioned below the inspected object 669.

In FIG. 8, both the illumination path and the collection path are normal to the inspected object 669 but this is not necessarily so and at least one path can be oriented to the normal.

As illustrated in FIG. 9, the filter 620 follows the illumination source 610 and the near infrared component of the first beam impinges on the inspected object 669 at an angle of about 60 degrees. The second beam includes a near infrared component that passes through the inspected object 669 and is collected by the imaging lens 634 and then directed towards sensor 640.

The inspected object 669 may include silicon and metal structures (it may be a silicon wafer) and the sensor 640 may be located to sense a near infrared spectral component of the second beam that passes through the inspected object 669. Silicone is virtually transparent to near infrared radiation and imaging system 800 can provide information about metal elements of such an inspected object 669.

Either one of inspection systems 600, 700 and 800 can operate in a near infrared mode in which the sensor 640 detects near infra red radiation.

Additionally or alternatively, either one of inspection systems 600, 700 and 800 can operate in a visible light mode in which the sensor 640 detects visible light. Additionally or alternatively, either one of inspection systems 600, 700 and 800 can operate in a hybrid mode in which the sensor 640 detects both visible light and near infrared radiation.

The switching between modes may include re-configuring or switching the filter 620. The filter 620 can include multiple filtering components that can be mechanically replaced by each other to facilitate the different modes of operation. The filters can be mechanically moved to be in the path of either the first or second beams or be away from such a path. For example, band pass filter the blocks visible light radiation and passes near infrared radiation can be replaced by a filter that passes visible light radiation or by a filter that blocks near infrared radiation and passes visible light radiation. The filters can be located on a torrent that can be rotated about its center to expose a beam to different filters.

Inspection systems 600 and 700 can be used for various purposes. For example, these inspection systems can be used to inspect objects that have metal elements (such as conductors or pads) that may be oxidized, and additionally or alternatively, can be used to inspect objects that include metal elements and laminate or dielectric elements. Non-limiting examples include PCB that may include a White Teflon™ or Alumina substrate, and the like.

Such inspection systems can be used to sense near infrared radiation within a near infrared band that ranges between 820 nm to 1100 nm. Such inspection systems can, for example, reduce Copper Oxide false errors (false positives), can increase the global contrast of Oxides in various layers of the PCB (or other inspected objects, e.g. other electrical circuits) such as inner layers, outer layers and White Teflon™ layers, increases the local contrast of small features with and without Oxides.

According to an embodiment of the invention the filter may pass only a portion of the near infrared range. For example, passing near infrared spectral components of higher wavelengths can decrease the difference between pixels obtained by illuminating Copper and Copper Oxides.

The illumination angle of either one of the inspection systems 600, 700 and 800 can be altered or be arranged to differ from normal illumination. It has been found that greater deviations of the illumination angle from normal illumination can reduce the unwanted effect of oxidations.

Either one of inspection systems 600, 700 and 800 can use longer wavelengths (in the near infrared band) such as to increase the contrast between Copper and Glass-Epoxy (e.g. Inner, Outer Layers) and between Copper and White Teflon™ laminate.

Although FIGS. 7-9 illustrate inspection systems 600, 700 and 800 it noted that this is for simplicity of explanation and each of these systems can be (or can operate) as a verification station. Additionally or alternatively, a combination of inspection systems and verification stations can be provided.

According to an embodiment each system (for example—600 and 700) can switch between operating modes (visible, near infrared and hybrid). Additionally or alternatively, each system (for example—systems 7600 and 700) can switch between optical characters (resolution, magnification, spectral filtering, angle of illumination, type of illumination, angle of collection, type of collection—bright field, dark field and the like). As illustrated, for example, in stage 1610 of FIG. 17, the determination for switching can be done by the operator or can be a part of an inspection recipe. The determination may be triggered by a completion of a portion of an inspection recipe, can be triggered by events such as a detection of defects, an end of an inspection of a predefined area of an inspected object and the like. For example, more critical areas (to the functionality of the inspected object) or more error prone areas can be inspected by two different modes. The switching between types of illumination and/or collection can be done in any manner known in the art.

When inspecting (or performing a verification process) the following process can be executed:

i. Scan panel/side/batch of inspected objects on any inspection system

ii. Verify each panel/side/batch of inspected objects on a verification station

iii. During verification—look on an image of a suspected defect (for example—by video).

iv. If the image of the suspected defect is not “clear” then change optic configuration—Changing resolution, Light configuration, Ratio or type . . . (can by NW, OR light or any other).

v. Continue verification process on the said panel/side.

FIG. 10 illustrates an image 900 and a binary image 905 of an area of an inspected object acquired with a near infrared radiation band of 830-1100 nm, according to an embodiment of the invention.

Image 900 includes images 902-904 of three octagons of a first material, these images are surrounded by an image 901 of another material that forms a background to the octagons. These first and second materials can be laminate and copper. There is a clear contrast between the images 902-904 of the three octagons and the image 901 of the background. All pixels or almost all pixels of the images 902-904 of the three octagons are darker than almost all (or all) pixels of the image of the background—thus, image 900 can be binarized to provide binary image 906 that includes three black images 907-909 of the octagons, these three images are surrounded by a white image 906 that represents the background.

FIG. 11 illustrates an image 910 and a binary image 915 of the same area of the inspected object as illustrated in FIG. 10 but acquired with a radiation band of 650-900 nm.

Image 920 includes images 912-914 of three octagons of the first material, these images are surrounded by an image 911 of a background made of another material. Many pixels of the images 912-914 of the three octagons are darker than many pixels of the image 911 of the background. Many pixels of the images 912-914 of the three octagons are brighter than many pixels of the image 911 of the background. Accordingly—image 910 cannot be binarized in a manner that provides an exact representation of the octagons and of the background.

Binarized image 919 includes images 916-918 of three black octagon-shaped rings having a white center and a background image 919 that includes a majority of white pixels but many black pixels 920. The black pixels 920 and the white centers can cause false positives.

FIGS. 12 and 13 include images 1100 and 1200 of narrow conductors placed on a White Teflon™ laminate material, image 1100 obtained with radiation within a near infrared band of 830-1100 nm, and image 1200 obtained with radiation that ranges between 650-900 nm. These figures also illustrate histograms 1120 and 1220 of portions 1110 and 1210 of images 1100 and 1200.

The contrast between the narrow conductors and the White Teflon™ laminate material in image 1100 is sharper than the corresponding contrast in image 1200. The narrow conductors of image 1100 are brighter and are more homogenous than the corresponding narrow conductors of image 1200.

Portions 1110 and 1210 include pixels from an area that includes the ends of two narrow conductors and a surrounding dielectric material. The histogram 1120 of portion 1110 includes a region that includes most pixels and has two major peaks and the gray level value of Oxidized Copper is positioned outside this region. The histogram 1220 of portion 1210 includes a region that includes most pixels and has two major peaks and the gray level value of Oxidized Copper is positioned within this region—between the two peaks.

FIGS. 14 and 15 include images 1300 and 1400 a PCB that include copper conductors placed on a laminate material, image 1300 obtained with radiation within a near infrared band of 830-1100 nm, and image 1400 obtained with radiation that ranges between 650-900 nm. These figures also illustrate enlarged portions 1310 and 1410 of images 1300 and 1400.

Fine defects (very bright pixels) can be better viewed in enlarged portion 1310 of image 1300. This enlarged portion 1310 includes more information about the shape of these fine defects then enlarged portion 1410 of image 1400.

According to an embodiment of the invention, an imaging (and/or inspection) method is disclosed, the method includes directing near-infrared illumination onto an object (e.g. an electrical circuit, a PCB board), and imaging reflected near infrared illumination which is reflected from the object by a sensor that is adapted to image at least in a portion of the near infrared spectrum. According to an embodiment of the invention, the imaging includes imaging at least a portion of the reflected illumination which is reflected from a copper part of the object and/or imaging at least a portion of the reflected illumination which is reflected from a copper compound (e.g. cupric oxide, cuprous oxide) part of the object.

According to an embodiment of the invention, the illuminating includes blocking illumination in frequencies other than near infrared. It should be noted that preventing infrared illumination (e.g. mid infrared, far infrared), by way of example, prevents image quality degradation and even unnecessary heating of the object. It is noted that various embodiments of the method may include various embodiments discussed in relation to the aforementioned systems.

FIG. 16 illustrates method 1500 for defect detection, according to an embodiment of the invention.

Method 1500 includes stage 1510 of generating a first beam that includes a near infrared spectral component and a visible light component. The near infrared spectral component of the first beam may be weaker than the visible light component of the first beam.

Stage 1510 may include generating a first light beam wherein the near infrared spectral component of the first beam may be substantially weaker than the at least one visible light component of the first light beam.

The near infrared band may range between a wavelength of about 700 nanometers and a wavelength of about 1100 nanometers. The near infrared spectral component of the first beam may be at least ten times weaker than the visible light component of the first beam.

Stage 1510 is followed by stage 1520 of directing at least the near infrared spectral component of the first beam towards an inspected object.

Stage 1520 may include directing the first beam at an angle that is normal to the inspected object. Alternatively, stage 1520 may include directing the first beam that is oriented in relation to an imaginary normal to the inspected object by at least twenty degrees or by at least sixty degrees.

Stage 1520 is followed by stage 1530 of directing, towards a sensor, a near infrared spectral component of a second beam generated from the illuminating of the inspected object; wherein the sensor is sensitive to visible light radiation and to near infrared radiation.

FIG. 16 illustrates stage 1540 as being parallel to stage 1530. This is not necessarily so. For example, stage 1540 can preceded either one of stages 1520 and 1530. Stage 1540 includes substantially preventing radiation outside a near infrared band from reaching the sensor.

Stage 1530 and optionally stage 1540 are followed by stage 1550 of generating, by the sensor, detection signals that are responsive to the near infrared component of the second beam.

Stage 1550 is followed by stage 1560 of detecting defects in the inspected object by processing the detection signals.

It is noted that the first beam can illuminate a small area or a large area of the inspected object. This area can have different shapes. In order to illuminate multiple areas of the inspected object, method 500 may include illuminating one area after the other and obtaining detection signals representing multiple areas. This is represented by a dashed arrow from box 1550 to box 1510. This repetition may include using pulsed illumination, continuous illumination, optically scanning the inspected object, mechanically moving the inspected object, mechanically moving the optics, and the like.

Method 500 can be applied in a reflective mode or in a transmissive mode. Referring to the examples set forth in previous figures, method 500 can be executed by either one of inspection systems 600, 700 and 800.

Method 500 can be applied to inspect an inspected object that includes silicon and metal structures, and stage 1550 may include generating, by the sensor, detection signals that are responsive the near infrared spectral component of the second beam that passes through the inspected object.

Method 500 can be applied to inspect metal elements of an inspected object and stage 1550 may include generating, by the sensor, detection signals that are substantially indifferent to different levels of oxidation of the metal elements of the inspected object.

The sensor may be a visible light sensor that is also arranged to sense near infra red radiation.

FIG. 17 illustrates method 1600 for defect detection, according to an embodiment of the invention.

Method 1600 differs from method 1500 by including multiple operational modes—a near infrared mode in which method 1500 is executed, a visible light mode in which visible light images are acquired and processed, and a hybrid mode in which images that are sensitive to both visible light and near infrared radiation are acquired. This hybrid mode can be implemented by not blocking visible light and near infrared radiation.

Method 1600 includes stages 1610, 1620, 1622, 1630, 1632, 1640 and 1620.

Stage 1610 includes determining an operational mode of the inspection system. The determination is made by an operator or can be a part of an inspection recipe. The determination may be triggered by a completion of a portion of an inspection recipe, can be triggered by events such as a detection of defects, an end of an inspection of a predefined area of an inspected object and the like. For example, more critical areas (to the functionality of the inspected object) or more error prone areas can be inspected by two different modes.

The operational mode can include a near infrared mode and at least one mode out of a visible light mode and hybrid mode. FIG. 17 illustrates all three modes.

If stage 1610 includes determining to operate in a near infrared mode then stage 1610 is followed by stage 1620 of configuring an inspection system to operate in a near infrared mode. Stage 1620 is followed by stage 1622 of operating in a near infrared mode. The configuration can include altering a characteristic of an illumination unit, of a filter or of optics. The configuration can include replacing a component, adjusting a component and the like. For example an inspection system can include a bank of filters and the configuration can include selecting one filter of the bank.

Stage 1622 can include at least some of the stages of method 1500—and can include all the stages of method 1500. For example, stage 1622 may include: (i) generating a first beam that includes a near infrared spectral component and a visible light component; (ii) directing at least the near infrared spectral component of the first beam towards an inspected object; (iii) directing, towards a sensor, a near infrared spectral component of a second beam generated from the illuminating of the inspected object; wherein the sensor is sensitive to visible light radiation and to near infrared radiation; (iv) substantially preventing radiation outside a near infrared band from reaching the sensor; (v) generating, by the sensor, detection signals that are responsive to the near infrared component of the second beam; and (vi) detecting defects in the inspected object by processing the detection signals.

If stage 1610 includes determining to operate in a visible light mode then stage 1610 is followed by stage 1630 of configuring an inspection system to operate in a visible light mode. The configuration can include altering a characteristic of an illumination unit, of a filter or of optics. The configuration can include replacing a component, adjusting a component and the like. For example an inspection system can include a bank of filters and the configuration can include selecting one filter of the bank.

Stage 1630 is followed by stage 1632 of operating in a visible light mode. Stage 1632 may include: (i) generating a first beam that includes a near infrared spectral component and a visible light component; (ii) directing at least the visible light component of the first beam towards an inspected object; (iii) directing, towards a sensor, the visible light component of a second beam generated from the illuminating of the inspected object; wherein the sensor is sensitive to visible light radiation and to near infrared radiation; (iv) substantially preventing radiation outside the visible light band from reaching the sensor; (v) generating, by the sensor, detection signals that are responsive to the visible light component of the second beam; and (vi) detecting defects in the inspected object by processing the detection signals.

If stage 1610 includes determining to operate in a hybrid mode then stage 1610 is followed by stage 1640 of configuring an inspection system to operate in a hybrid mode. The configuration can include altering a characteristic of an illumination unit, of a filter or of optics. The configuration can include replacing a component, adjusting a component and the like. For example an inspection system can include a bank of filters and the configuration can include selecting one filter of the bank.

Stage 1640 is followed by stage 1642 of operating in a hybrid mode. Stage 1642 may include: (i) generating a first beam that includes a near infrared spectral component and a visible light component; (ii) directing the near infrared spectral component and the visible light component of the first beam towards an inspected object; (iii) directing, towards a sensor, a near infrared spectral component and a visible light component of a second beam generated from the illuminating of the inspected object; wherein the sensor is sensitive to visible light radiation and to near infrared radiation; (iv) substantially preventing radiation outside a near infrared band and outside the visible light band from reaching the sensor; (v) generating, by the sensor, detection signals that are responsive to the near infrared component and to the visible light component of the second beam; and (vi) detecting defects in the inspected object by processing the detection signals.

Backside Inspection

A wafer may include at their upper side multiple metal layers that prevent the inspection of elements that may be buried under the surface of the wafer. The backside of wafer is made of silicone that is transparent to near infrared radiation. Accordingly—backside inspection can provide information about buried elements.

There may be provided a method to inspect the backside of a wafer. A near infra-red (NIR) radiation beam is used to illuminate the back side of the wafer. The silicon is transparent to near infrared light but has good reflection from other material such as copper enabling the measurements of the back side of the wafer. The light is reflected from the various layers and elements within the wafer to the sensor. An image is constructed on the sensor by the reflected light from the sensor.

The reflectance amplitude is a function of the spectral composition of the illumination light, the thickness and the index of refraction of each layer.

The near infrared illumination spectrum may present within the range of 700 nanometers to 1400 nanometers.

The object material could be silicon which has good transmission in the NW spectrum range. Features and components which are developed from the front side of the wafer, such as copper-filled TSVs, will reflect the NIR with substantial amplitude.

This NIR image will be used to perform the alignment of the object during inspection of the wafer' back side.

Furthermore, the thickness of the remaining silicon on top of the copper-filled TSV is measured with high accuracy using the NW illumination. This will enable to control the thinning process of the wafer.

FIG. 22 is a cross sectional view of a portion 2100 of a wafer that illustrated in an inverted position—where its backside 2120 is upwards. Referring to FIGS. 7-8 any of the inspected objects 669 may be such a wafer and its backside 2120 is upwards.

FIG. 22 illustrates the portion 2100 as including a metal upper layer 2110, a bulk (or substrate) 2120, a bottom surface 2122, five through silicon vias (TSVs) 2131-2134 and 2136 and an empty TSV hole 2135.

The TSVs are expected to be buried in the substrate—and be positioned at a certain distance 2126 from the bottom surface 2122. The edges of the TSVs are expected to be positioned at a fixed distance from the bottom surface 2122. The bottom surface 2122 and these edges virtually form (or virtually define) a layer 2124 of silicone is expected to be virtually formed between the TSVs and the bottom surface. The height of layer 2124 should be within a predetermined range.

FIG. 22 illustrates a defective TSV 2133 that extends through the entire layer 2124 can be visible when inspecting the backside using visible radiation. When using near infrared radiation TSV 2133 reflects radiation at a much higher intensity that the radiation reflected by other TSVs (2131, 2132, 2134 and 2136) buried in the substrate. This high intensity reflection is indicative of the defective TSV.

TSV hole 2135 should have been filled with a copper (or other metal composition) to form a TSV—and an near infrared image of portion 2100 lacks a reflection that should have been received if TSV hole 2135 was properly filled. This is also indicative of a defect.

It may be expected that the near infrared image is less sensitive to the exact depth of the TSVs and thus may provide a rough estimate of defects.

FIG. 18 illustrates method 1700 according to an embodiment of the invention.

Method 1700 may start by stage 1710 of generating a first beam that comprises a near infrared spectral component and a visible light component.

Stage 1710 may be followed by stage 1720 of directing at least the near infrared spectral component of the first beam towards a backside of an inspected object, the backside includes first elements made of a first material and second elements that are made of a second material. The first material is substantially transparent (allows passage of infrared radiation to propagate through to first material—to a depth that may be in the scale of microns, millimeters and the like) wherein the second material is arranged to reflect near infrared radiation.

Stage 1720 may be followed by stage 1730 of directing, towards a sensor, a near infrared spectral component of a second beam generated from the illuminating of the inspected object. The sensor is sensitive to visible light radiation and to near infrared radiation.

Stage 1730 may be followed by stage 1740 of generating, by the sensor, detection signals that are responsive to the near infrared component of the second beam.

Stage 1740 may be followed by stage 1750 of detecting at least one attribute of at least the second elements by processing the detection signals. The attribute can be a location of the second elements, the size and/or shape of the second elements, the depth of the second elements within the backside and the like.

The first material may be silicon and the second material may be metal.

Stage 1750 may be followed by stage 1760 of feeding the locations of the second elements to a second element measurement process. The second measurement process may be more accurate than the process of stages 1710-1750. It may be a spectrometry reflection measurement process. The second measurement process may measure the second elements, their location and the like. The location can include their depth within the backside (distance from the lower surface of the backside).

For example, stage 1750 may provide the location of second elements (such as TSVs) and therefore may provide alignment information of such TSV over the entire wafer (or a selected part of the wafer). These locations may be provided to a second measurement process that may involve metrology of remaining silicon (thickness) in predefined locations (depth of TSVs within the silicon). This metrology process of the remaining silicon is very slow procedure since the field of view of precise metrology tool is very small. Finding the bottom of TSV and mapping all (or most) of them in aligned manner highly assists in further metrology. Method 1700 allows to map and navigate properly through an enormous number of TSVs and perform sampling metrology according to the predefined scheme.

Stage 1750 may include detecting a lack of reflection from a location in which a second element was expected to appear and defining the second element as defective.

Additionally or alternatively, stage 1750 may include detecting a second element that is not buried in the first material by receiving a detection signal that exceeds an expected reflection threshold.

The second elements may be buried within the first material—and are expected not to reach the bottom surface of the backside. Stage 1750 may include determining, for at least one second element, a thickness of a first material layer that is formed between the second element and a bottom surface of the backside.

Inspection of Wafer Level Package (WLP) Wafer

In the production of MEMS applications (for example), such as various sensors and optical devices, wafers are required to be bonded as a part of the production process.

During the bonding process various defects may be added to the wafers, some of which are internal defects (either in the bonding layer or on the bonded surfaces) examples for such defects can be: Voids in the bonding layer, excessive bonding material, particles on the bonded surfaces, scratches on the bonded surfaces.

After assembly, these defects can only be detected using wavelengths that can penetrate the silicone structure.

In these cases near Infra-Red in the wavelengths of 1200-1400 is used. These wavelengths penetrate the silicone layers and provide a good image of both the bonding material and the particles caught between the wafers.

Furthermore, near infrared inspection can assist in detecting alignment targets located in different portions of the WLP wafer—including alignment targets located in a lower wafer, intermediate elements and the upper wafer. Box-in-box alignment targets or any other type of alignment targets can be imaged by using near infrared inspection and the spatial relationship between different alignment targets can assist in determining the alignment between the upper wafer, intermediate elements and lower wafer. The alignment may be represented by an alignment parameter.

FIG. 21 illustrates a wafer level package (WLP) wafer 2000. The WLP wafer includes upper wafer 2030 (having an upper surface 2032), a lower wafer 2010, intermediate elements 2011 and bonding material elements. The bonding material elements include (i) upper bonding materials elements 2021, 2022 and 2024 that bond upper wafer 2030 to the intermediate elements 2011 and form a bonding layer 2020 and (ii_{—} lower bonding material elements 2041, 2042, 2043 and 2044 that bond the intermediate elements 2011 to the lower wafer 2010.

The gaps formed between intermediate elements 2011, the upper wafer 2030 and the lower wafer 2030 are expected to be free of bonding material. Bonding material element 2044 includes excessive bonding material (left end—bonding material not directly below intermediate element 2011) and the presence of bonding material element at such a gap may be regarded as a defect.

The bonding material elements are expected to expand across the entire top of each of the intermediate elements 2011 . Bonding material elements 2022 and 2020 seem to be in a proper condition. Bonding material element 2021 is too short—does not cover the entire upper surface e (edge) of intermediate element 2011 and illustrates a lack of bonding material. The bonding material element that should have been positioned between the third to the left intermediate element is entirely missing—as illustrated by gap 2023.

Although the upper wafer 2030 is transparent to near infrared radiation voids (2034) and scratches can be detected as they change the reflected radiation from the upper wafer 2030 (or from reflecting elements located beneath them).

FIG. 19 illustrates method 1800 according to an embodiment of the invention.

Method 1800 may start by stage 1810 of generating a first beam that comprises a near infrared spectral component and a visible light component.

Stage 1810 may be followed by stage 1820 of directing at least the near infrared spectral component of the first beam towards a group of bonded wafers. The wafer level packaging may include an upper wafer, a lower wafer and bonding material for bonding the upper wafer to the lower wafer. It is noted that the group can include one or more intermediate wafers located between the lower and upper wafers and there can be multiple bonding material layers—between each pair of wafers of the group.

Stage 1820 may be followed by stage 1830 of directing, towards a sensor, at least a near infrared spectral component of a second beam generated from the illuminating of the inspected object. The sensor is sensitive to visible light radiation and to near infrared radiation.

Stage 1830 may be followed by stage 1840 of generating, by the sensor, detection signals that are responsive to the near infrared component of the second beam.

Stage 1840 may be followed by stage 1850 of detecting defects positioned below an upper surface of the upper wafer by processing the detection signals.

Stage 1850 may include at least one out of (i) detecting defects (such as 2036 and 2034) of the upper wafer that are positioned below the upper surface of the upper wafer, (ii) detecting defects (such as 2025 and lack of bonding material of element 2023) in the bonding material, such as lack of bonding material and/or presence of bonding material at locations that are expected to be free from bonding material, and (iii) detecting defects in the lower wafer (such as void 2014).

Verification

FIG. 20 illustrates method 1900 according to an embodiment of the invention. Method 1900 may start by stage 1910 of generating a first beam that comprises a near infrared spectral component.

Stage 1910 is followed by stage 1920 of directing the near infrared spectral component of the first beam towards metal elements of an inspected object.

Stage 1920 may be followed by stage 1930 of directing, towards a sensor, a near infrared spectral component of a second beam generated from the illuminating of the inspected object. The sensor is sensitive to near infrared radiation.

Stage 1930 may be followed by stage 1940 of generating, by the sensor, detection signals that are substantially indifferent to different levels of oxidation of the metal elements of the inspected object.

Stage 1940 may be followed by stage 1950 of processing the detection signals.

Stage 1950 may include at least one out of: (i) processing the detection signals to detect defects; (ii) processing the detection signals to verify suspected defects.

Stage 1930 may include substantially preventing radiation outside a near infrared band from reaching the sensor.

The first beam may also include a visible light component.

This near infra read inspection (or verification) sequence (stage 1910 and 1940) may be followed by or preceded by a visible light inspection (or verification) sequence. The transition between these sequences can be triggered by a person, can be performed in an automatic manner, according to a recipe, in response to the processing results and the like.

Stage 1910-1940 may be preceded by a visible light inspection (or verification) sequence 1905 of (a) generating a certain light beam; (b) directing the certain light beam towards the metal elements of the inspected object; (c) directing, towards the sensor, a visible light spectral component of another beam generated from the illuminating of the inspected object (the other beam can be a beam that is beam reflected or scattered from the inspected object); wherein the sensor is sensitive to visible light radiation and the other beam differs from the certain light beam that illuminates the inspected object ; (d) generating, by the sensor, certain detection signals; and (e) processing the certain detection signals.

Stage 1905 may also include determining, in response to the certain detection signals that there is a need to perform a near infrared inspection of the inspected object.

Additionally or alternatively, stage 1905 may include receiving, from a person, instructions to perform a near infrared inspection of the inspected object.

Stage 1950 may be followed by visible light inspection (or verification) sequence 1960 of (a) generating a certain light beam; (b) directing the certain light beam towards the metal elements of the inspected object; (c) directing, towards the sensor, a visible light spectral component of another beam generated from the illuminating of the inspected object; wherein the sensor is sensitive to visible light radiation; (d) generating, by the sensor, certain detection signals; and (e) processing the certain detection signals.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. The method according to claim 45 wherein the directing of the at least one spectral component of the first beam towards the inspected object comprises:
directing at least a near infrared spectral component of the first beam towards a backside of the inspected object, the backside comprises first elements made of a first material and second elements that are made of a second material; wherein the first material is substantially transparent to near infrared radiation and wherein the second material is arranged to reflect near infrared radiation;
wherein the directing towards the sensor the at least one spectral component of the second beam comprises
directing, towards the sensor, a near infrared spectral component of the second beam;
wherein the generating of the detection signal comprises generating, by the sensor, detection signals that are responsive to the near infrared component of the second beam.

2. The method according to claim 1, wherein the first material is silicon and the second material is metal.

3. The method according to claim 1, wherein the at least one attribute of the second elements comprises locations of the second elements.

4. The method according to claim 3, further comprising feeding the locations of the second elements to a second measurement process.

5. The method according to claim 1, wherein the processing comprises detecting a lack of reflection from a location in which a second element was expected to appear and defining the second element as defective.

6. The method according to claim 1, wherein the processing comprises detecting a second element that is not buried in the first material by receiving a detection signal that exceeds an expected reflection threshold.

7. The method according to claim 1, wherein the second elements are through silicone vias.

8. The inspection system according to claim 44 wherein the first beam that comprises a near infrared spectral component and a visible light component;
wherein the optics are arranged to:
direct at least the near infrared spectral component of the first beam towards a backside of the inspected object, the backside comprises first elements made of a first material and second elements that are made of a second material; wherein the first material is substantially transparent to near infrared radiation and wherein the second material is arranged to reflect near infrared radiation;
direct, towards the sensor, a near infrared spectral component of the second beam;
wherein the sensor is arranged to detect signals that are responsive to the near infrared component of the second beam.

9. The inspection system according to claim 8, wherein the first material is silicon and the second material is metal.

10. The inspection system according to claim 8, wherein the at least one attribute of the second elements comprises locations of the second elements.

11. The inspection system according to claim 8, wherein, the processing circuit is further arranged to feed the locations of the second elements to a second measurement tool.

12. The inspection system according to claim 8, wherein the processing circuit is arranged to detect a lack of reflection from a location in which a second element was expected to appear and defining the second element as defective.

13. The inspection system according to claim 8, wherein the processing circuit is arranged to detect a second element that is not buried in the first material by receiving a detection signal that exceeds an expected reflection threshold.

14. The inspection system according to claim 8, wherein the second elements are through silicone vias.

15. The inspection system according to claim 8, wherein the second elements are buried within the first material and wherein the processing circuit is arranged to determine, for at least one second element, a thickness of a first material layer that is formed between the second element and a bottom surface of the backside.

16. The inspection system according to claim 15, wherein the processing circuit is arranged to control a thinning process of the inspected object in response to the thickness of the first material later.

17. The method according to claim 45 wherein the inspected object is a group of bonded wafers;
wherein the directing of the at least one spectral component of the first beam towards the inspected object comprises:
directing at least a near infrared spectral component of the first beam towards the group of bonded wafers that comprises an upper wafer, a lower wafer and bonding material for bonding the upper wafer to the lower wafer;
wherein the directing towards the sensor the at least one spectral component of the second beam comprises
directing, towards the sensor, a near infrared spectral component of the second beam;
wherein the generating of the detection signal comprises
generating, by the sensor, detection signals that are responsive to the near infrared component of the second beam; and
wherein the processing of the detection signals comprises
detecting defects positioned below an upper surface of the upper wafer.

18. The method according to claim 17 comprising detecting defects of the upper wafer that are positioned below the upper surface of the upper wafer.

19. The method according to claim 17 comprising detecting defects in the bonding material.

20. The method according to claim 20 comprising wherein the defects in the bonding materials comprises (i) lack of bonding material; (ii) presence of bonding material at locations that are expected to be free from bonding material.

21. The method according to claim 20 comprising detecting defects in the lower wafer.

22. The inspection system according to claim 44 wherein the first beam that comprises a near infrared spectral component and a visible light component;
wherein the optics is arranged to:
direct at least the near infrared spectral component of the first beam towards a wafer level packaging wafer that comprises an upper wafer, intermediate elements a intermediate elements and a lower wafer and bonding material for bonding the intermediate elements to the upper wafer and to the lower wafer;
direct, towards a sensor, a near infrared spectral component of the second beam
wherein the sensor is arranged to detect signals that are responsive to the near infrared component of the second beam; and
wherein the processing circuit is arranged to detect defects positioned below an upper surface of the upper wafer by processing the detection signals.

23. The method according to claim 22 comprising, wherein the processing circuit is arranged to detect defects of the upper wafer that are positioned below the upper surface of the upper wafer.

24. The method according to claim 22, wherein the processing circuit is arranged to detect defects in the bonding material.

25. The method according to claim 22, wherein the processing circuit is arranged to detect at least one defect out of (i) a lack of bonding material; and (ii) presence of bonding material at locations that are expected to be free from bonding material.

26. The method according to claim 22, wherein the processing circuit is arranged to detect defects in the lower wafer.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. A system, comprising:
an illumination source that is arranged to generate a first beam;
a sensor;
optics arranged to:
direct at least one spectral component of the first beam towards an inspected object;
direct, towards a sensor, at least one spectral components of a second beam generated from the illuminating of the inspected object; wherein the sensor is sensitive to at least one spectral component out of an near infrared spectral component and visible light spectral component;
wherein the sensor is arranged to generate detection signals; and
a processing circuit that is arranged to process the detection signals;
wherein the system is arranged to operate in either one of a visible light mode, a near infrared mode and a hybrid mode;
wherein when the system operates in the visible light mode the detection signals are responsive to a visible light spectral component of the second beam;
wherein when the system operates in the near infrared mode the detection signals are responsive to a near infrared spectral component of the second beam; and
wherein when the system operates in the hybrid mode the detection signals are responsive to a visible light spectral component of the second beam and to a near infrared spectral component of the second beam.

45. A method, comprising:
setting a system to operate in a mode of operation out of a visible light mode, a near infrared mode and a hybrid mode;
generating a first beam;
directing at least one spectral component of the first beam towards an inspected object;
directing, towards a sensor, at least one spectral components of a second beam generated from the illuminating of the inspected object; wherein the sensor is sensitive to at least one spectral component out of an near infrared spectral component and visible light spectral component;
generating detection signals; and
processing the detection signals;
wherein when the system operates in the visible light mode the detection signals are responsive to a visible light spectral component of the second beam;
wherein when the system operates in the near infrared mode the detection signals are responsive to a near infrared spectral component of the second beam; and
wherein when the system operates in the hybrid mode the detection signals are responsive to a visible light spectral component of the second beam and to a near infrared spectral component of the second beam.

46. (canceled)

47. The method according to claim 48 comprising determining an alignment parameter between the at least two entities based upon a spatial relationship between the alignment targets.

48. The inspection system according to claim 22 wherein the processing circuit is arranged to process the detection signals to detect alignment targets positioned in at least two out entities out of the upper wafer, the lower wafer and the intermediate elements.

49. The method according to claim 48 wherein the processing circuit is arranged to process the detection signals to determine an alignment parameter between the at least two entities based upon a spatial relationship between the alignment targets.

50. The method according to claim 4, comprising feeding the second measurement process with a map of second elements.

51. The method according to claim 4, wherein the second measurement process measures a depth of the second elements within the backside.

52. The method according to claim 4, wherein the second measurement process exhibits a field of view that is a fraction of a cross section of the first beam.
